(19) United States
(12) Patent Application Publication
(10) Pub. No.: US 2019/0267705 A1
(43) Pub. Date: Aug. 29, 2019

(54) RADAR MODULE FOR A VEHICLE

(71) Applicant: Robert Bosch GmbH, Stuttgart (DE)

(72) Inventors: Michael Klar, Magstadt (DE); Andreas Pietsch, Bietigheim-Bissingen (DE); Armin Himmelstoss, Weissach Im Tal (DE); Hartmut Kittel, Weissach-Flacht (DE); Maik Hansen, Leonberg (DE); Saeed Arafat, Leonberg (DE); Thomas Schmidt, Backnang (DE)

(21) Appl. No.: 16/331,041

(22) PCT Filed: Jul. 5, 2017
(86) PCT No.: PCT/EP2017/066841

§ 371 Date: Mar. 6, 2019

(30) Foreign Application Priority Data
Sep. 8, 2016 (DE) 10 2016 217 057.0

(51) Int. Cl. H01Q 1/42; B60Q 1/00

(52) U.S. Cl. CPC H01Q 1/42; G01S 2007/027; B60Q 1/0023

(57) ABSTRACT

A vehicle includes a body having a body outer element that has an external surface, and a radar module having a radar sensor, a housing that accommodates the radar sensor and that has a housing opening situated in the direction of detection of the radar sensor, and a radome fastened on the housing that closes the housing opening in the manner of a cover. The radome forms a part of the external surface of the body outer element.

### CROSS-REFERENCE TO RELATED APPLICATIONS

The present application is the national stage of International Pat. App. No. PCT/EP2017/066841 filed Jul. 5, 2017, and claims priority under 35 U.S.C. § 119 to DE 10 2016 217 057.0, filed in the Federal Republic of Germany on Sep. 8, 2016, the content of each of which are incorporated herein by reference in their entireties.

### FIELD OF THE INVENTION

The present invention relates to a vehicle having a body and a radar module installed in an open fashion, whose radome is fashioned as part of a body outer element of the vehicle. The present invention also relates to a corresponding radar module for such a vehicle.

### BACKGROUND

In modern motor vehicles, radar sensors are used to sense the environment surrounding the vehicle. The radar sensors are installed inside the vehicle in the form of pre-manufactured radar modules that, in addition to the radar sensor, also include a housing containing the radar sensor and a radome mounted on the housing in the direction of detection of the radar sensor. Motor vehicle radar units currently in use are tested, after being manufactured, as finished radar modules in the production facility, and are subsequently installed at the vehicle manufacturer behind various body outer parts, such as vehicle emblems, structural plates, painted bumpers, or in an open manner. The body outer part situated in front of the radar module here influences both its range and the angular quality of the respective radar module. Therefore, the demands placed on the radar module must correspondingly make allowance for this influence. In addition, the installation of motor vehicle radar modules behind plates having grille structures, such as radiator grilles or air inlet grilles, is currently not possible, or is possible only with optical limitations.

### SUMMARY

An object of the present invention is therefore to provide a possibility for housing radar modules in a vehicle without the disadvantages known from the existing art.

According to an example embodiment of the present invention, a vehicle includes a body having a body outer element that has an external surface. The vehicle further includes a radar module having a radar sensor, a housing that accommodates the radar sensor and that has a housing opening situated in the direction of detection of the radar sensor, and a radome fastened on the housing that closes the housing opening in the manner of a cover. The radome forms a part of the external surface of the body outer element. The design of the radome as a part of the outer body of the vehicle enables the open, i.e., not covered, mounting of the radar module in the vehicle. Because in this case no additional body elements are situated in front of the radar sensor, the radar module, or the radar sensor situated therein, can be calibrated already at the production facility. In this way, possible risks relating to the previous variance at the location of installation are eliminated. Because the radar module is no longer installed behind a body outer part, an installation position that is positioned as far forward as possible can be realized. This results in a particularly large field of view of the radar module that can be realized only with difficulty in radar modules that are mounted in covered fashion. Through the greater field of view of the radar module, inter alia pedestrian protection is improved. Through the use of radar modules having a radome that has a vehicle-specific design, the technical demands made on the sensor with regard to capacity for being installed at non-optimal installation locations can be significantly reduced. This results in a corresponding potential for greater system performance. Differing from this, in the case of radar modules installed in covered fashion there is always an influence of the vehicle-specific body outer elements installed in front of them, such as bumpers, an emblem, or a structured plate. Such an influence cannot be tested during the manufacture of the radar modules; rather, allowance has to be made for it as a corresponding performance reserve.

Due to the open installation of the radar module equipped with the radome having a vehicle-specific design, additional safeguarding with regard to range, angular errors, and ghost targets is no longer necessary. Due to the omission of this previous safeguarding outlay, the manufacturing outlay and manufacturing costs are reduced. Due to the integration of the radar module inside a body outer element of the vehicle, installation locations are now available in the vehicle for the installation of the radar module that were previously not possible, for example for design reasons.

In a example embodiment, the body outer element has an opening in its external surface, the radome being situated inside the opening. In this way, a particularly simple mounting of the radar module on the body outer part can be realized.

In an example embodiment, the radome has an external surface that terminates substantially flush with the external surface of the body outer element. In this way, an optimal integration of the radar module in the body outer element can be realized. Here, a particularly forward position of installation of the radar module in the vehicle is achieved, enabling a particularly large field of view of the radar sensor. In this way, inter alia the pedestrian protection realized by the radar unit is improved. An external surface of the radome that terminates flush with the external surface of the body outer part also offers aerodynamic advantages and in addition is largely inconspicuous, which in principle allows the radar module to be installed at any location of the vehicle front.

In an example embodiment, the external surface of the radome has a structuring that matches a structuring of the external surface of the body outer element. The identical structuring enables the function, the design, and the aerodynamic properties of the radome to be adapted to the corresponding properties of the body outer element.

In an example embodiment, the external surface of the radome is coated with a layer of paint or film that matches the coating of the external surface of the body outer element. The identical realization of the external surfaces of the radome and of the body outer element permits the inconspicuous installation of the radar module at almost any location on the outer body of the vehicle. This enables an arbitrary adaptation of the field of view of a corresponding radar system. In an example embodiment, the coat of paint is made transparent to radar. In this way, possible power losses of the radar sensor can be reduced.

In an example embodiment, the radome is realized in the form of a structured plate of a radiator grille or air inlet grille or in the form of a vehicle emblem. This enables particularly inconspicuous installation of the radar module in the vehicle outer body.

In an example embodiment, the radar module is situated in the front area of the vehicle.

In the following, the present invention is explained in more detail on the basis of figures.

### BRIEF DESCRIPTION OF THE DRAWINGS

FIG. 1 shows a schematic cross-sectional representation through a known radar system including a radar module installed behind a body outer element.

FIG. 2 shows a schematic cross-sectional representation through a radar system including a radar module situated in an opening of a body outer part, according to an example embodiment of the present invention.

FIG. 3 shows the radar system having a radome that has a coating, according to an example embodiment of the present invention.

FIG. 4 shows a schematic cross-sectional representation of a radar module installed in open fashion in an opening of a body outer element, having a radome curved so as to match the body outer element, according to an example embodiment of the present invention.

FIG. 5 shows a schematic cross-sectional representation through a radar module installed in open fashion in a body outer element and having a structured external surface, according to an example embodiment of the present invention.

FIG. 6 shows a perspective representation of a radar module having a painted external surface for open mounting in a corresponding opening of a body outer element, according to an example embodiment of the present invention.

FIG. 7 shows a perspective representation of a radar module having a structured radome for open installation and a corresponding opening of a radiator grille or air inlet grille, according to an example embodiment of the present invention.

FIG. 8 shows the front of a vehicle having a radar module installed in open fashion in a front bumper, according to an example embodiment of the present invention.

FIG. 9 shows a radar module installed in open fashion in a radiator grille of a vehicle, having a correspondingly structured external surface of the radome of the sensor, according to an example embodiment of the present invention.

FIG. 10 shows a radar module installed in open fashion in an opening of a radiator grille, having a design coating, according to an example embodiment of the present invention.

### DETAILED DESCRIPTION

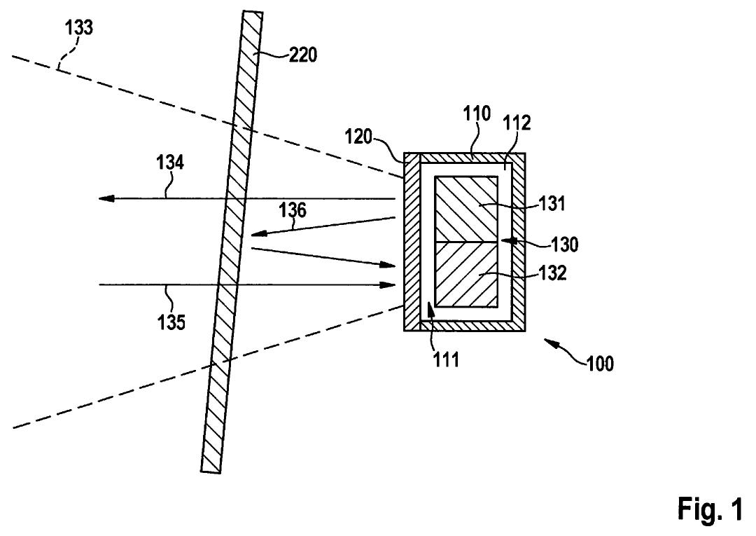

Conventional radar modules are mounted behind elements of the outer body in vehicles. FIG. 1 shows such a radar module 100 having a concealed installation, fastened as a finally mounted component behind a body outer element 220 such as a bumper or a radiator grille or air inlet grille. Here, radar module 100 has a housing 110 having a receptacle space and having a radar sensor 130 situated in the receptacle space. On a side corresponding to the direction of detection of radar sensor 130, the housing has an opening 111 that is closed in the manner of a cover by a radome 120 of the housing. Radar module 100 formed in this way forms a compact component that is supplied in finished form by the manufacturer of the vehicle, and is installed on the vehicle using corresponding fastening means. As can be seen in FIG. 1, radar sensor 130 preferably has a transmitter 131 for producing radar radiation 134 and a receiver 132 for receiving radar radiation 135 reflected back from objects in field of view 133 of the radar sensor. Transmitter 131 and receiver 132 can also be realized in the form of a common component.

During operation, radar sensor 110 emits, via its transmitter 131, radar radiation having at least one wavelength, which leaves radar module 100 via the radome 120 of the housing. Radar radiation 134, indicated by an arrow in FIG. 1, subsequently passes through body outer part 220 situated in field of view 133 of radar sensor 130. If in the environment surrounding the vehicle there is situated an object that reflects back the light radiation 134 emitted by radar sensor 130, the light radiation 135 reflected back reaches receiver 132 of radar sensor 130. As indicated by a corresponding arrow, the radar reflection 135 reflected back again passes through body outer part 220 situated in front of radar module 100. Depending on the properties of body outer part 220, such as its layer thickness, its material composition, or its surface structure, the transmission through body outer part 220 causes a change of phase and of the direction of propagation of radar radiation 134, 135. In addition, due to absorption inside body outer part 220 and reflection at its surface, there are power losses of the relevant radar radiation 134, 135. As indicated in FIG. 1 by arrow 136, radar radiation 135 reflected on the surface of body outer part 220 also causes interference signals that can appear in the radar image for example in the form of ghost images. Due to the named effects, a precise calibration of radar sensor 130 therefore cannot take place until after radar module 100 has been installed behind body outer part 220. In addition, in the case of radar sensor 120 installed in covered fashion, corresponding reserves must be planned in order to compensate the named power losses.

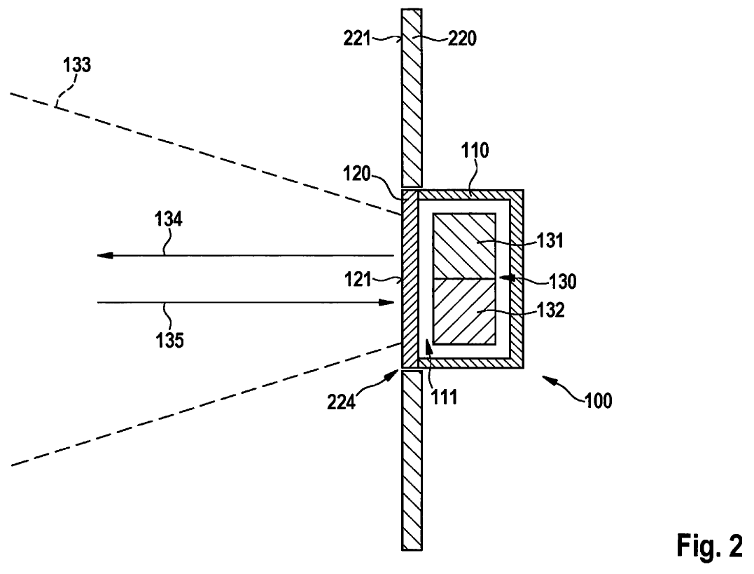

FIG. 2 shows a system having a radar module 100 installed in open fashion according to an example embodiment of the present invention. For this purpose, radar module 100 is mounted in an opening 224 of a body outer element 220, so that radome 120 of the housing itself forms a part of the outer body of vehicle 200. Here, external surface 121 of radome 120 of the housing preferably matches external surface 221 of body outer element 220. As can be seen in FIG. 2, in this configuration radar sensor 130 can now emit or receive radar radiation 134, 135 without interference due to body parts situated in front of it. Due to the position of installation of radar module 100, which is further forward relative to the system of FIG. 1, overall there results a larger and less distorted field of view 133 of radar module 100.

Differing from the conventional concealed design of the radar module of FIG. 1, in the case of radar module 100 installed in open fashion, body outer element 220 no longer has to be made of a material transparent to radar. In addition, the complete calibration of the radar sensor can take place already at the manufacturer of the radar module, so that a further calibration of the installed radar module 100 at the vehicle manufacturer is no longer necessary.

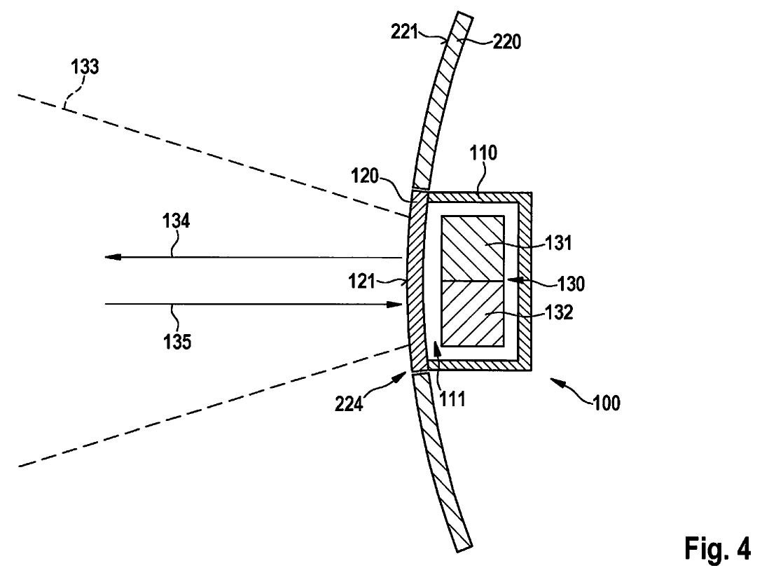

In an example embodiment, the housing radome 120 of radar module 100 installed in open fashion is formed in such a way that its appearance and its functionality match the appearance and functionality of body outer element 220 to the greatest possible degree. For this purpose, FIG. 4 shows as an example a radar module 100 installed in an opening 224 of a body outer element 220 having a curvature. Housing radome 220 of radar module 100 here also has a corresponding curvature, which fits into the curvature of body outer element 220 without a seam. Such a design has, inter alia, particularly good aerodynamic properties. In addition, this design also provides the possibility of installing the radar module at locations of the vehicle that up to now were considered unsuitable for this purpose, and therefore were not taken into consideration. These include for example the engine hood, the fender or a corresponding bumper, or a covering element situated under the bumper.

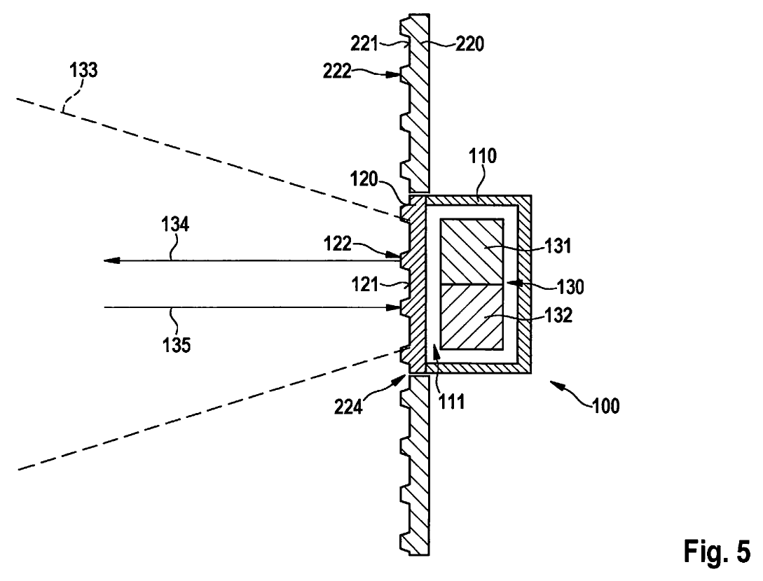

Alternatively or in addition to the curvature determined by body outer element 220, housing radome 120 of radar module 100 according to the present invention can in addition also have a structuring that matches the structuring of the corresponding body outer element 220. FIG. 5 shows a corresponding example embodiment, in which body outer element 220 has grille-type structures 222. These can be for example radiator grilles or air inlet grilles in the front area of the vehicle. Because radar sensor 130 is already delivered as a finished radar module, the interference effects on emitted or received radar radiation 134, 135, caused by structures 122 situated on external surface 121 of housing radome 120, can be taken into account already during the calibration of the radar module at the production facility.

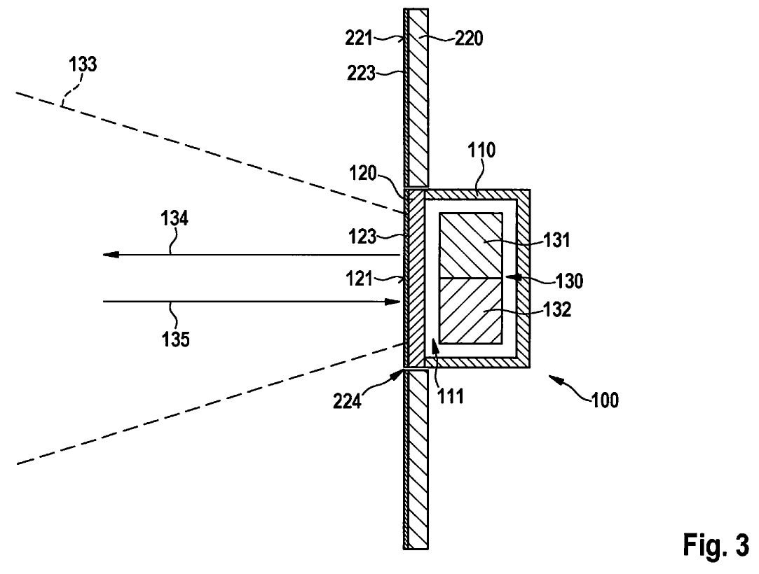

FIG. 3 shows an example embodiment of radar module 100 having open installation. Depending on the location of installation of radar module 100 in vehicle 200, housing radome 120 is equipped, in an example embodiment, with an outer coating 123. This can for example be a coat of paint that matches the outer coat of paint 223 of body outer element 220. This embodiment is particularly advantageous if radar module 100 is installed in the engine hood, in a fender, a bumper, or some other front covering of the vehicle. The material of coating 123 of radome 120 can also be different from the material of coating 223 of body outer element 220. This makes sense in particular if in this way a better transparency to radar of radome 120 is achieved.

As coating 123, in addition to a coat of paint, a film coating is also possible. Both the paint coating and also the film coating are preferably optimized with regard to the best possible radar transparency. In addition, the material of housing radome 120 can already have a color that matches the coloring of external side 221 of body outer element 220.

In principle, it is also possible for external surface 121 of housing radome 120 to be made different in its color and structure from external surface 221 of body outer element 220. Such an embodiment can be implemented, for example, to use housing radome 120 as a design element. An example of this is given by the vehicle-specific emblem, which is typically situated in the front area of the vehicle.

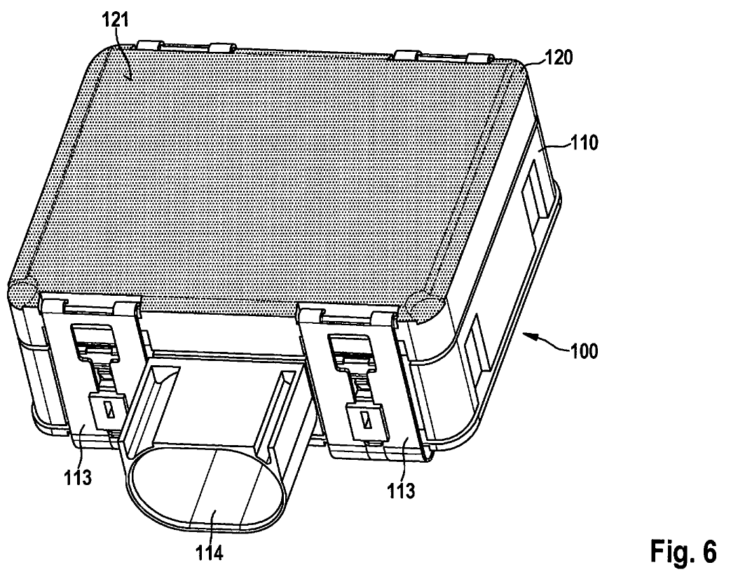

FIG. 6 shows an example embodiment of a radar module 100 that has a housing radome 120 designed specifically for open installation in the vehicle. Radome 120 has an external surface 121 that matches, in its color and structure, the outer body of the vehicle. A radar module designed in this way is provided in particular for installation in a surface-type outer body element surface, such as an engine hood, a fender, a bumper, or some other front covering of the outer body.

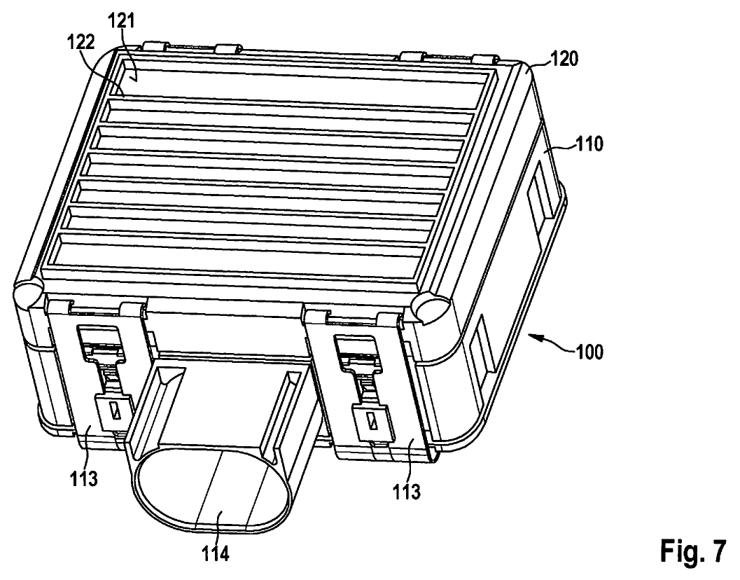

In contrast, FIG. 7 shows a radar module 100 having a housing radome 120 having groove structures 122 fashioned on its external surface 121. This radar module 100 is provided for example for open installation in a radiator grille or air inlet grille.

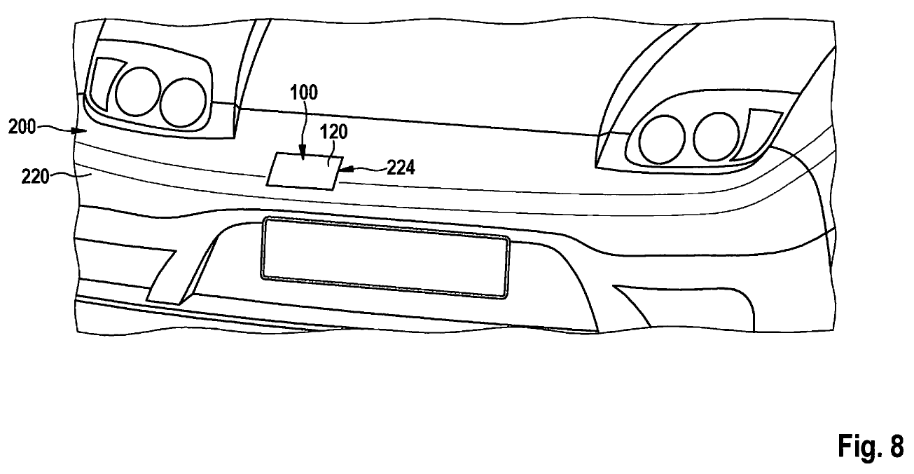

FIG. 8 shows a front area of a vehicle 200 having a body outer part 220. Body outer part 220, realized in the form of a bumper in the present example embodiment, has an opening 224 in which housing radome 120 of a radar module 100 mounted on body outer part 220 is situated.

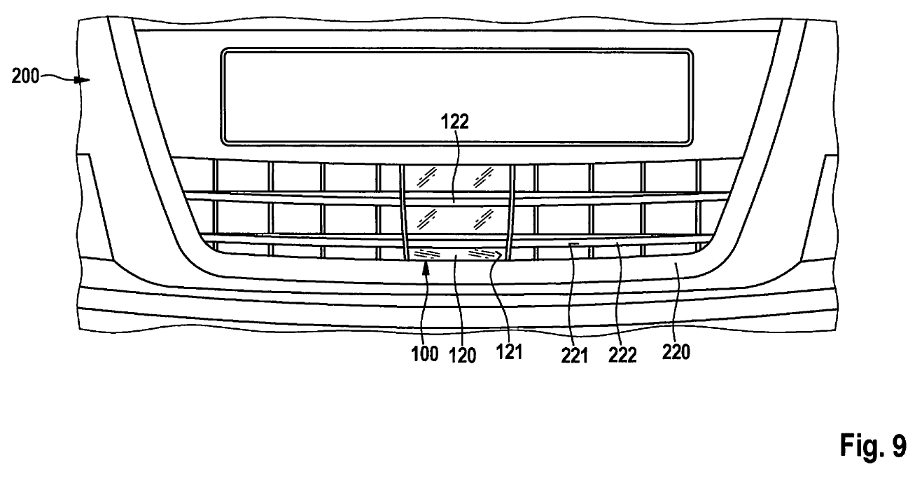

FIG. 9 shows a possible example embodiment of the use of a housing radome of FIG. 7, equipped with blade structures. Radar module 100 is here mounted inside a radiator grille 220 in the front area of vehicle 200. Structures 122 of housing radome 120 are here preferably situated flush with grille structures 222 of radiator grille 220.

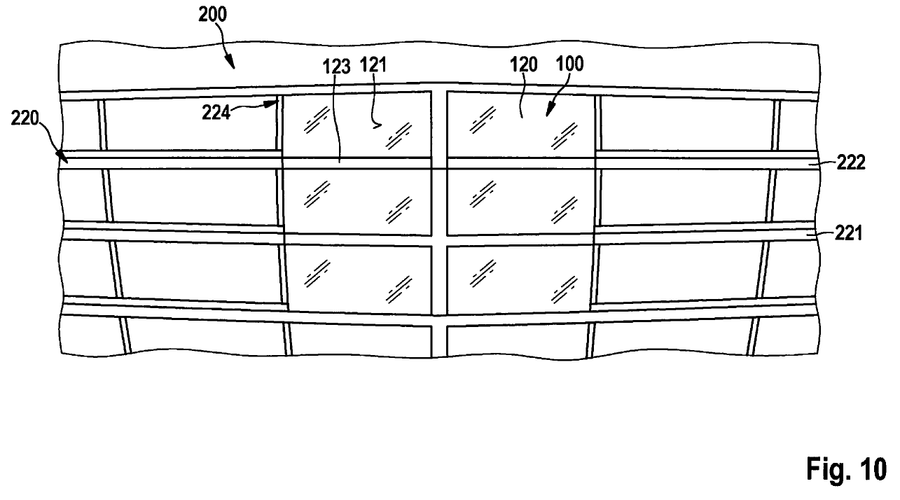

FIG. 10 shows, as an example, a use of the housing radome as a vehicle-specific emblem, analogous to the example embodiment of FIG. 9. Radar module 100 is situated in an opening or recess 24 inside a radiator grille 220. However, housing radome 120 does not have a corresponding structuring. Rather, external side 121 of housing radome 120 is provided with a color pattern 123. In the present example embodiment, color pattern 123 matches the pattern of grille structures 222 of radiator grille 220. Color pattern 123 on external side 121 of 120, contrasting with the color of the background, can however in principle be realized in any design, e.g., in the form of a vehicle-typical emblem, such as the trademark of the particular vehicle. Color markings 123 can be produced by applying a corresponding coating, such as a coat of paint or a film, onto the external side of radome 120. In principle, a combined realization of the external side of radome 120 using structures and colored markings can also be provided.

Although the present invention has been described above on the basis of concrete example embodiments, it is in no way limited thereto. The person skilled in the art will thus be able to suitably modify the described features and combine them with one another without departing from the core of the present invention.

1-10. (canceled)

11. A vehicle comprising:
a vehicle body; and
a radar module that includes:
a radar sensor;
a housing that accommodates the radar sensor and that has a housing opening situated in the direction of detection of the radar sensor; and
a radome fastened on the housing as a cover that closes the housing opening, wherein an external surface of the radome is an extension of an external surface of the vehicle body.

12. The vehicle of claim 11, wherein the vehicle body includes an opening in the external surface, and the radome is situated inside the opening.

13. The vehicle of claim 11, wherein the external surface of the radome is substantially flush with the external surface of the vehicle body.

14. The vehicle of claim 11, wherein the external surface of the radome includes structure that match structures of the external surface of the vehicle body.

15. The vehicle of claim 11, wherein the external surface of the radome is coated with a paint layer or film layer that matches a coating of the external surface of the vehicle body.

16. The vehicle of claim 11, wherein the external surface of the radome is coated with a layer of paint that is transparent to radar and that matches a coating of the external surface of the vehicle body.

17. The vehicle of claim 11, wherein the radome is formed as a structured plate of a radiator grille or air inlet grille or as a vehicle emblem.

18. The vehicle of claim 11, wherein the radar module is situated in a front area of the vehicle.

19. A radar module comprising:
a radar sensor;
a housing that accommodates the radar sensor and that has a housing opening situated in the direction of detection of the radar sensor; and
a radome fastened on the housing as a cover that closes the housing opening, wherein an external surface of the radome is part of an external surface of a body of a vehicle.

20. The radar module of claim 19, wherein the radome is formed as a structured plate of a radiator grille or air inlet grille or as a vehicle emblem.

21. The radar module of claim 19, wherein the radome is painted or coated with a film of other portions of the external surface of the body of the vehicle.
